(19) United States
(12) Patent Application Publication
(10) Pub. No.: US 2003/0081619 A1
(43) Pub. Date: May 1, 2003

(54) Hybrid fiber coax communication system

(76) Inventors: Bruce A. Phillips, Erie, CO (US); John M. Czak, Aurora, CO (US)

Correspondence Address: QWEST COMMUNICATIONS INTERNATIONAL INC, LAW DEPT INTELLECTUAL PROPERTY GROUP, 1801 CALIFORNIA STREET, SUITE 3800, DENVER, CO, 80202, US

(21) Appl. No.: 10/004,465

(22) Filed: Nov. 1, 2001

(51) Int. Cl. H04L 12/28

(52) U.S. Cl. 370/400; 370/535; 725/114

(57) ABSTRACT

A hybrid fiber coaxial communication (“HFC”) system configured to provide voice, video, and data services between a headend and a user gateway device at synchronous optical network (“SONET”) transmission rates. The HFC system comprises a broadband terminal in a headend, an optical to electrical (“O/E”) conversion node and a user gateway device. The user gateway device is located in a subscriber premise and provides the voice service to call devices, the video service to video display devices, and the data service to data display devices directly connected to the user gateway. The broadband terminal is configured to exchange voice, video, and data traffic with the user gateway via the O/E conversion node at SONET transmission rates. The optical to electrical conversion node is configured to convert upstream and downstream communications between optical carrier transmission rates and their electrical equivalent transmission rates.

### FIELD OF THE INVENTION

The invention is related to the field of broadband communications and specifically to a hybrid fiber coaxial communication system that provides broadband services at synchronous optical network (“SONET”) transmission rates between a headend and a customer premises.

### BACKGROUND OF THE INVENTION

Traditional cable television (“CATV”) systems are designed to broadcast analogue television signals from a reception center or headend to connected subscribers. The basic system architecture includes a coaxial trunk connected between the headend and a plurality of distribution points, known in the art as neighborhood nodes. These neighborhood nodes are connected to feeder coaxial cables, known in the art as coaxial plants, which are tapped by coaxial drop cables that reach individual subscriber homes.

In recent years, coaxial trunks between the headend and the neighborhood nodes have been replaced by fiber optic cables to create a new architecture, known in the art as a hybrid fiber coax (“HFC”) system. These HFC systems combine many of the best features of coaxial and fiber-optic cable to offer broadband services such as voice, video, and data services. Additionally, they provide a cost effective way to increase bandwidth needed for emerging broadband applications, as they are far less expensive than full fiber-to-the-curb or switched digital video solutions.

FIG. 1 illustrates a typical HFC system architecture. On FIG. 1, a headend 100, a neighborhood node 111, a network interface device (“NID”) 107, and a customer premise 114 are depicted. The headend 100 includes a host digital terminal 101 and a forward path transmitter 102. The neighborhood node 111 includes an optical to electrical (“O/E”) conversion node 103. The customer premise 114 includes a set top box (“STB”) 104 connected to a television 112, a cable modem 105 connected to a computer 113, and a telephone 106. A pair of fiber optic cables, 109 and 110, connect the headend 100 to the O/E conversion node 103. A coaxial feeder cable 108 connects the O/E conversion node 103 to the NID 107. The NID 107 in turn is connected to the STB 104, the cable modem 105, and the telephone 106 in the customer premises 114.

The HDT 101 operates as a switch router and exchanges voice communications between the headend 100 and the O/E conversion node 103 over the optic path 109. The forward path transmitter 102 modulates combines and exchanges video and data signals with the O/E conversion node 103 over the optic path 110. The O/E conversion node 103 converts the voice video and data signals into a radio frequency (“RF”) signal and outputs the RF signal over the coaxial cable 108 to the NID 107. The NID 107 separates the voice video and data signals and provides the voice signals to the telephone 106, the video signals to the STB 104 and the data signals to the cable modem 105. The STB 104 tunes in the desired video channel and outputs the video channel signal to the television 112. The cable modem 105 demodulates the data signal and provides the data signal to the computer 113. Upstream voice, video, and data signals are also exchanged with the headend 100 in a similar but reverse fashion.

Unfortunately, while present HFC systems significantly improve over CATV systems, they still rely on digital encapsulation of the voice, video, and data signals into an analogue frequency range. These systems typically utilize a 6 MHz downstream channel with an RF range between 50 and 450 MHz and an upstream channel with an RF range between 5 MHz and 42 MHz between the headend 100 and the NID 107. In some cases, additional downstream channels are also provided for interactive services with a RF range between 450 MHz and 750 MHz.

### SUMMARY OF THE INVENTION

The present invention advances the art by providing an HFC communication system configured to provide voice, video, and data services between a headend and a user gateway device at synchronous optical network (“SONET”) transmission rates. The present HFC communication system comprises a broadband terminal in a headend, an optical to electrical (“O/E”) conversion node, and a user gateway device.

The user gateway device is located in a subscriber premise and provides the voice service to call devices, the video service to video devices, and the data service to data devices directly connected to the user gateway. The call devices, video display devices and data devices could be conventional telephones, televisions, and computers.

The broadband terminal is configured to exchange voice, video, and data communications with the user gateway via the O/E conversion node at SONET transmission rates. The optical to electrical conversion node is configured to receive downstream communications from the headend over an optical communication link at optical carrier transmission rates and convert the optical carrier transmission rates into their electrical equivalent transmission rates and provide the downstream communications over a coaxial distribution link to the user gateway at the electrical equivalent of the optical carrier transmission rates. The O/E conversion node is also configured to receive upstream communications from the user gateway device over the coaxial distribution communication link at the electrical equivalent of optical carrier transmission rates and convert the electrical transmissions into their optical carrier transmission rate equivalents and provide the upstream communications over the optical communication link to the headend at the optical carrier transmission rates.

The SONET transmissions provide the physical transport layer for various interoperability standards that could be used according to the present invention. Some examples of these interoperability standards include without limitation, Asynchronous Transfer Mode (“ATM”), Internet Protocol (“IP”) and Moving Pictures Experts Group (“MPEG”) using time division multiple access (“TDMA”) and code division multiple access (“CDMA”).

A first advantage of the present invention is that broadband voice, video, and data services are provided from the headend to a customer premise at digital transmission rates that are at least 51.840 Mbps or higher. A second advantage of the present invention is that the user gateway eliminates the need for separate cable modems and set top boxes to deliver the voice service to telephones, the video service to televisions, and the data service to computers. A third advantage of the present invention is that the user gateway communicates directly with the headend to provide interactive services and connection to other switched networks. This permits customers to select and schedule the delivery of various broadband services such as the delivery of different video options, e.g. movies, as well as the time that the service is provided. Additionally, this also provides access for customer equipment such as computers, telephones and televisions directly to other switched networks at SONET transmission rates.

### BRIEF DESCRIPTION OF THE DRAWINGS

The same reference number represents the same element on all drawings.

FIG. 1 illustrates a prior art system architecture for a hybrid coaxial communication system;

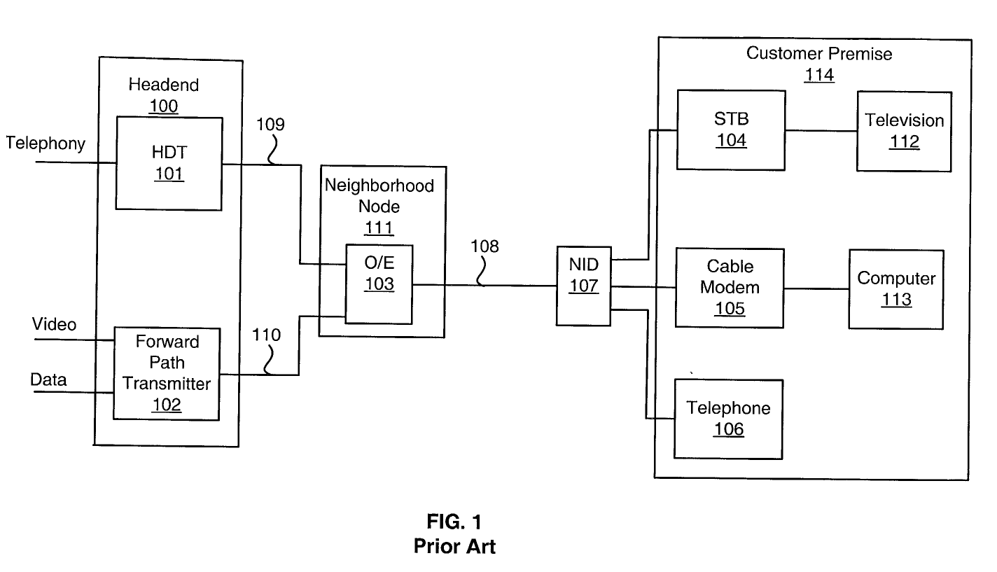

FIG. 2 illustrates a system architecture for a hybrid coaxial communication system according to the present invention;

FIG. 3 is a flowchart illustrating an example of the operation of the hybrid coaxial communication system according to the present invention;

FIG. 4 illustrates an example of a headend including a broadband terminal according to the present invention;

FIG. 5 illustrates an example of a user gateway for a hybrid coaxial communication system according to the present invention;

FIG. 6 is a message sequence chart illustrating an example the operation of the hybrid coaxial communication system according to the present invention;

FIG. 7 is another message sequence chart illustrating an example the operation of the hybrid coaxial communication system according to the present invention; and

FIG. 8 is another message sequence chart illustrating an example the operation of the hybrid coaxial communication system according to the present invention.

### DETAILED DESCRIPTION

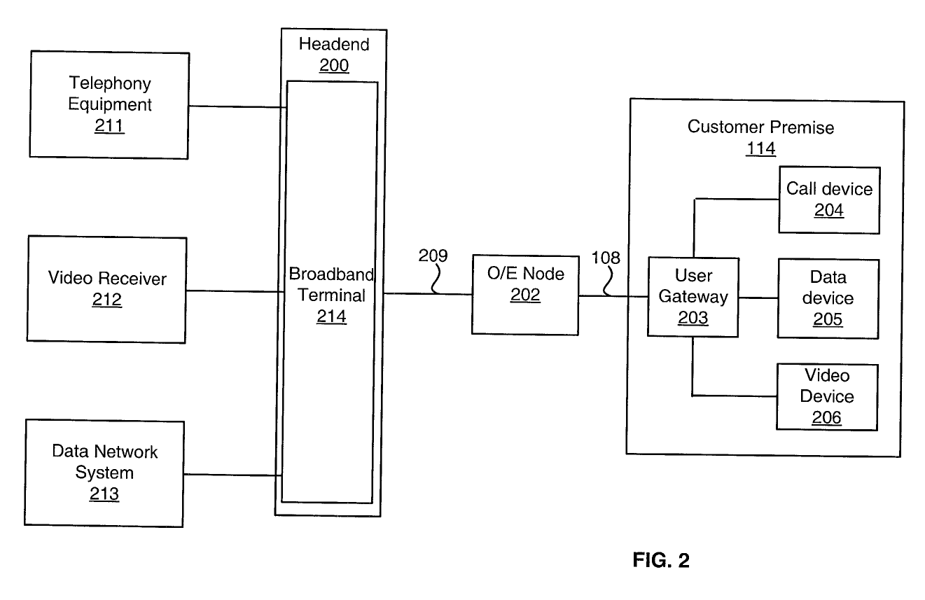

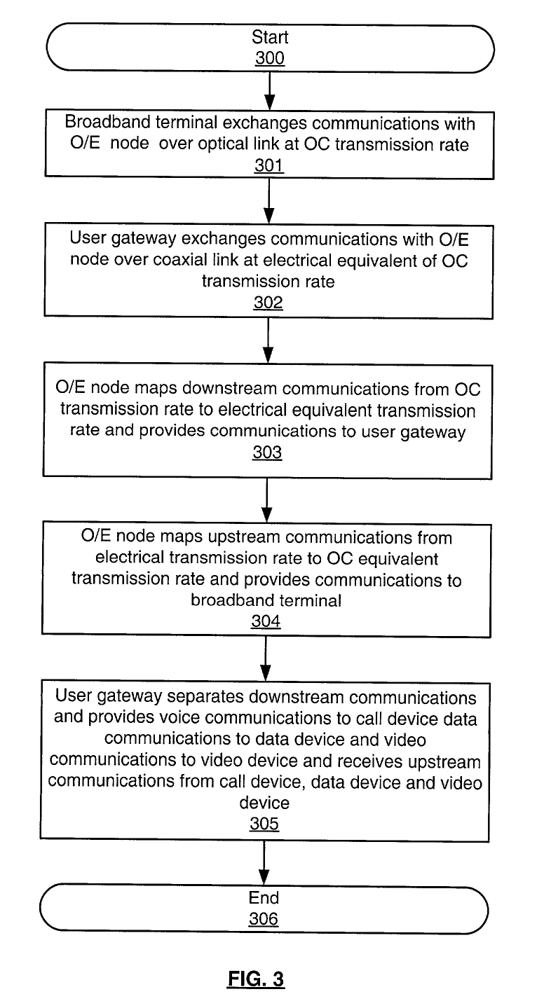

System Architecture and Operation FIGS. 2-3

FIG. 2 illustrates a system architecture according to the present invention. FIG. 2 depicts telephony equipment 211, a video receiver 212, a data network system 213, a headend 200, an O/E conversion node 202, and customer premise 114. The customer premise 114 comprises a user gateway 203 connected to a call device 204, a data device 205, and a video device 206. The headend comprises a broadband terminal 214 connected to the telephony equipment 211, the video receiver 212, the data network system 213, and the O/E conversion node 202. The O/E conversion node 202 is connected to the user gateway 203 at the customer premise 114.

The telephony equipment 211 could be any equipment, system, or network configured to bill authorize or exchange voice communication services with the headend 200. Some examples of the telephony equipment 211 include without limitation, a class five switch, the public switched telephone network or a central office. The video receiver 212 could be any equipment, system, or network configured to provide video services to the headend 200. The video services could be digital video services or analogue video services. In one example of the invention, the video receiver 212 is a conventional satellite receiver that receives video signals from one or more satellites and provides the video signals to the headend 200. The data network system 213 could be any network configured to bill, authorize or exchange data services with the headend 200. Some examples of the data network system 213 include without limitation, an Internet Protocol (“IP”), Frame Relay, or ATM network. In another example of the invention the data network 213 could be an Internet, a local area network (“LAN”), a wide area network (“WAN”), or a LAN connected to a WAN.

The broadband terminal 214 could be any device or group of devices configured to exchange the voice communication services between the user gateway 203 and the telephony equipment 211 at a SONET transmission rate, exchange the video services between the user gateway 203 and the video receiver 212 at the SONET transmission rate, and exchange the data communication services between the data network 213 and the user gateway 203 at the SONET transmission rate. The voice communication services could be conventional switched telephony services between the call device 204 and a terminating call device. The data communication services could be conventional data services such as web browsing, data file exchange and email. The video communication services could be conventional digital or analogue video services such as cable service, pay per view, or video on demand services.

The O/E conversion node 202 could be any device or circuitry configured to convert downstream optical transmissions into their electrical equivalent transmissions and convert upstream electrical transmissions into their optical equivalent transmissions. The SONET standard uses a family of optical carrier (“OC”) transmission rates and corresponding electrical equivalent transmission rates known as Synchronous Transport Signal (“STS”) transmissions. The SONET standard uses a base rate of 51.84 Mbps corresponding to an OC-1 optical signal or STS 1 electrical signal. Higher rate signals are multiples of the base rate signal, e.g. an OC 12/STS 12 signal has a rate of 12 times 51.84 Mbps. The O/E conversion node 202 is configured to map OC level transmissions into their corresponding STS level transmissions and map STS level transmission into corresponding OC level transmissions. In another example of the invention, the O/E conversion node 202 could be configured to convert the OC level transmissions into Synchronous Digital Hierarchy (“SDH”) transmissions as defined by the International telecommunication Union-Telecommunications Standardization Sector. SDH transmissions vary only slightly from STS transmissions in that their base level begins at 155 Mbps and the STS transmissions are known as Synchronous Transport Modules (“STM”).

The SONET, STS, and SDH transmissions provide the physical transport layer for various interoperability standards that could be used according to the present invention. Some examples of these interoperability standards include without limitation, Asynchronous Transfer Mode (“ATM”), IP, and Moving Pictures Experts Group (“MPEG”) using time division multiple access (“TDMA”), code division multiple access (“CDMA”), or other appropriate multiplexing technique. Thus, in one example of the present invention, the voice, video, and data communications could be exchanged between the broadband terminal 214 and the user gateway 203 using the ATM protocol. In another example of the present invention the voice, video, and data communications could be exchanged between the broadband digital terminal and the user gateway 203 using the IP protocol. In another example of the present invention, the voice, video, and data communications could be exchanged between the broadband terminal and the user gateway 203 using the frame relay protocol. In yet another example of the present invention, the video communications could be compressed using the MPEG standard. Those skilled in the art will appreciate that all of the above protocols could be multiplexed using CDMA, TDMA, or other appropriate multiplexing technique.

The user gateway 203 could be any device that is configured to provide an interface directly to customer premise equipment for the voice, video, and data services. Thus, in one example of the invention, the call device 204 could be a telephone, the data device 205 could be a computer, and the video device 206 could be a television. The user gateway 203 provides switched voice communication services directly to a call device 204, provides switched video communication services directly to the video device 206, and provides switched data services to the data device 205. It will be appreciated by those skilled in the art that providing the switched video service, as well as voice and data services, significantly reduces the bandwidth requirements for the HFC system according to the present invention. Also, advantageously, the user gateway 203 eliminates the other customer premises equipment used in prior art HFC systems such as set top boxes and cable modems to provide a single interface for the direct connection of voice, video, and data equipment. Additionally, the user gateway 203 communicates directly with the headend 200 to provide interactive services and connection to other switched networks using the broadband terminal 214. This permits customers to select and schedule the delivery of various broadband services such as the delivery of different video options, e.g. movies, as well as the time that the service is provided. Additionally, this also provides access for customer equipment such as computers, telephones and televisions directly to other switched networks at SONET transmission rates.

FIG. 3 is a flowchart illustrating an example of the operation of an HFC system according to the present invention. On FIG. 3 the operation begins at step 300. At step 301, the broadband terminal 214 exchanges downstream voice, video, and data communications with the O/E conversion node 202 over the optical communication link 109 at an OC transmission rate. Examples of the OC transmission rates include OC-1, OC-3, OC-9, OC-12, OC-18, OC-24, OC-36, OC-48, OC-96, and OC-192. At step 302, the user gateway 203 exchanges upstream voice, video, and data communications with the O/E conversion node 202 over the coaxial communication link 108 at an electrical equivalent of the OC transmission rate. At step 303, the O/E conversion node 202 maps the downstream voice, video, and data communications from the OC transmission rate to the electrical equivalent transmission rate and provides the downstream communications to the user gateway 203 over the coaxial communication link 108. For example, an OC 12 transmission is mapped to an STS 12 electrical transmission and an OC 48 is mapped to an STS 48 or STM 36 transmission rates etc. At step 304, the O/E conversion node 202 maps the upstream voice, video, and data communications from the electrical transmission rate to the OC equivalent transmission rate and provides the upstream communications to the broadband terminal 214 over the optic communication link 109. For example, an STS 12 electrical transmission is mapped to an OC 12 transmission rate and an STS 48 or STM 36 is mapped to an OC 48 transmission rate etc. At step 305, the user gateway 203 separates the downstream voice, video, and data communications and provides the voice communications to the call device 204, provides the data communications to the data device 205 and provides the video communications to the video device 206. The user gateway 203 also receives upstream voice video and data communications from the call device 204, data device 205, and video device 206 and provides the upstream communications to the broadband terminal 214. It will be appreciated that the above example is a broad example of the system operation and that not all communications between the broadband terminal 214 and the user gateway 203 will necessarily include a voice, video, and a data communication. For example, a subscriber at the customer premise 114 may use the call device 204 simultaneously with the video device 206 and not be using the data device 205. In this case the exchange of communications between the broadband terminal 214 and the user gateway 203 would include only the voice and video communications.

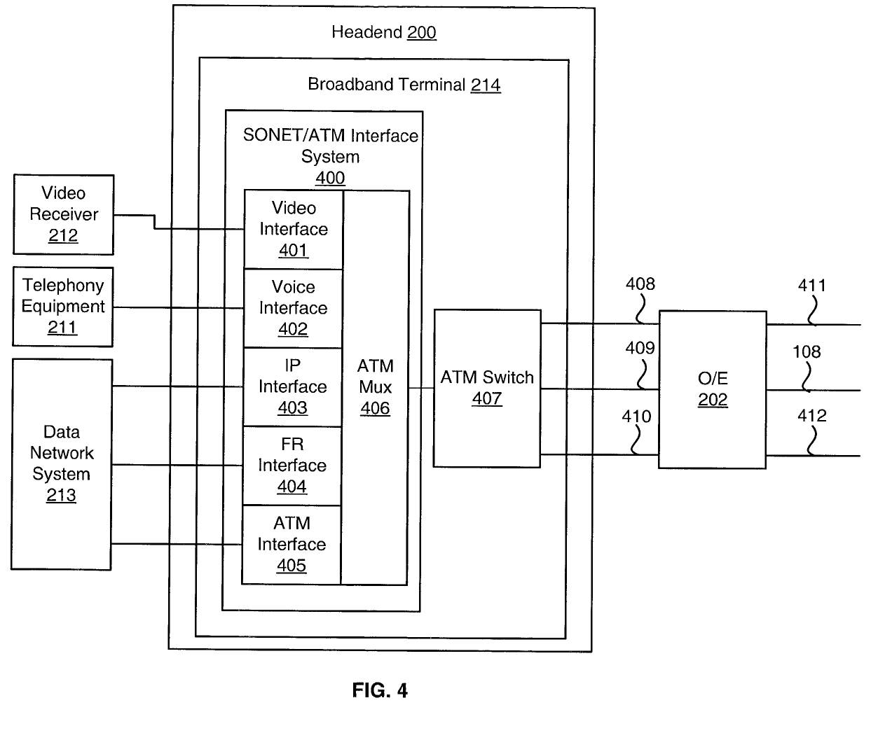

FIG. 4 illustrates an example of the headend 200 and broadband terminal 214 according to the present invention. Those skilled in the art will appreciate that the headend 200 would include other conventional components not shown on FIG. 4 for clarity. Those skilled in the art will also appreciate how the below described examples could be combined with the above described examples to form numerous additional examples in accordance with the principles of the present invention.

The broadband terminal 214 includes a SONET/ATM interface 400 connected to an ATM switch 407. The SONET/ATM interface 400 includes an ATM multiplexer 406 coupled to a video interface 401, a voice interface 402, an IP interface 403, a frame relay interface 404, and an ATM interface 405. To illustrate the principles of the present invention, the SONET/ATM interface 400 is shown with numerous interfaces, e.g. 401-405, but all of the interfaces are not required. Various combinations and sub-combinations of the interfaces, 410-405, could be used to access the multiplexer 406. Additionally, other interfaces not depicted could be incorporated into the SONET/ATM interface 400 that are compatible with SON ET/ATM traffic transport.

The IP interface 403 provides IP routing and exchange of data traffic between the ATM multiplexer 406 and the data network system 213. The IP interface 403 could include an IP router that supports priority levels and is compliant with ATM forum recommendations. The video interface 401 provides video service from the video receiver 212 to the headend 200. The video interface could include a codec for converting analogue signals to digital signals for packaging and transport in ATM cells by the ATM multiplexer 406. The video interface could also include an MPEG interface that compresses the received video according to the MPEG formatting standard for packaging and transport in ATM cells by the ATM multiplexer 406. The frame relay interface 404 provides connection and traffic routing to a frame relay network and the ATM interface 404 provides connection and traffic routing to an ATM network which could be part of the data network system 213. The voice interface 401 provides connectivity to the telephony equipment 211. The voice interface 401 could also route calls and call signals and channel voice lines.

The ATM multiplexer 406 receives traffic from the video interface 401, the voice interface 402, the IP interface 403, the frame relay interface 404, and the ATM interface 405, packages the communications into ATM cells and multiplexes the communications for the ATM switch 407. The ATM multiplexer 406 could include redundant OC 12 network interfaces and be able to differentiate data from voice. The ATM multiplexer 406 also supports Quality-Service (Qos) differentiation between voice and data and includes extensive traffic management features to protect the voice traffic. The ATM multiplexer 406 could also use a media access control protocol layer for controlling access and provisioning the voice, video, and data service over the present HFC system. Some examples of the ATM multiplexer 406 include without limitation a TDMA and CDMA multiplexer.

The ATM switch 407 is connected to fiber optic communication links 408, 409 and 410 that connect to the O/E conversion node 202. Those skilled in the art will appreciate that the ATM switch 407 could accommodate numerous such links although only links 408-410 are shown on FIG. 4 for clarity. In one example of the present invention, the links 408-410 could be OC-12 optical communication links. In another example of the invention, the links 408-410 could be OC-48 optical communication links. On FIG. 4 the O/E conversion node 202 also includes coaxial communication links 411 and 412 in addition to link 108 to illustrate that the O/E conversion node 202 services multiple customer premises, e.g. 114.

The ATM switch 407 exchanges the resulting SONET/ATM format from the ATM multiplexer 406 with the O/E conversion node 202 over the optic links 408-410. The ATM switch 407 provisions virtual channels and virtual paths for exchanging information between the broadband terminal 214 and user gateways, e.g. 203 located at customer premises, e.g. 114. The ATM switch 407 could set up and manage both permanent virtual connections, switched virtual connections or combinations of switched and permanent virtual connections. In one example of the invention, the ATM switch 407 could use a permanent virtual connection with the user gateway 203 to exchange the video communications and use switched virtual connections to exchange the data and voice communications with the user gateway 203. Other combinations of switched and permanent virtual connections could be used as a matter of design choice.

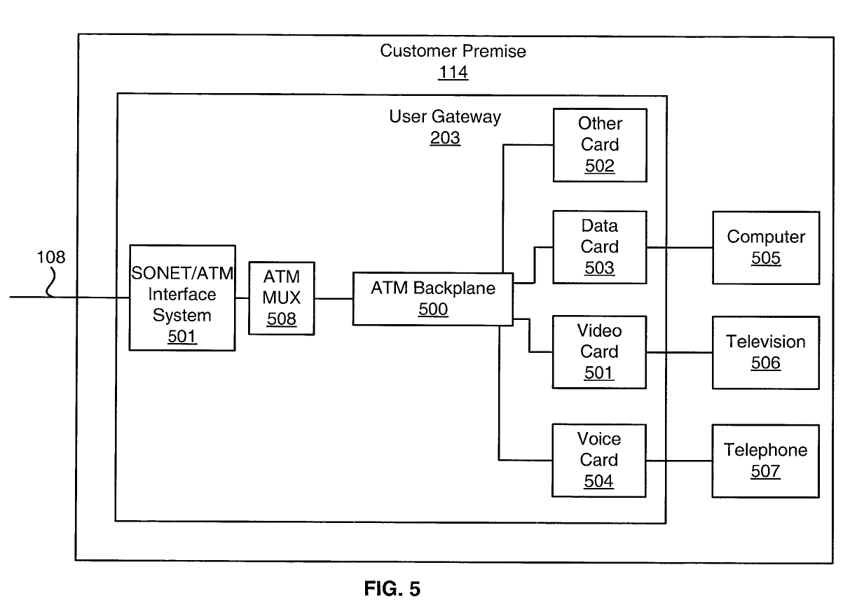

FIG. 5 illustrates an example of the customer premise 114 and the user gateway 203. The user gateway 203 is connected to the coaxial communication link 108, a computer 505, a television 506, and a telephone 507 in the customer premise 114. It will be appreciated that the user gateway 203 could accommodate connections to multiple other computers, telephones, and televisions although only computer 505, television 506, and telephone 507 are depicted on FIG. 5 as a matter of design choice. It will also be appreciated that the user gateway would also include numerous other conventional components such as a power supply and user interface.

The user gateway 203 is located at a customer premise, e.g. 114. The customer premise 114 is a residence or dwelling where people reside, such as a house, duplex, apartment, or condominium. The user gateway 203 provides digital video and data communications to the television 506 and the computer 505 respectively. The user gateway 203 could provide digital or analogue service to the telephone 507 as a matter of design choice. The user gateway executes software that will be apparent to those skilled in the art to direct system operation.

The SONET/ATM interface system 501 exchanges the STS or STM SONET transmissions between the user gateway 203 and the O/E conversion node 202 over the coaxial path 108. The SONET/ATM interface 501 converts control and communications ATM cells into SONET/ATM format for transport to the O/E conversion node 202. The SONET/ATM interface 501 receives control and communication ATM cells from the ATM multiplexer 508 and provides these to the appropriate one of the other card 502, the data card 503, the video card 501, and voice card 504 using the ATM backplane 500. The backplane 500 permits the ATM communications within the user gateway 203.

The ATM multiplexer 508 separates the incoming STS or STM voice, video, and data communications and provides the voice communications over the ATM backplane 500 to the voice card 504, provides the video communications over the ATM backplane 500 to the video card 501, and provides the data communications over the ATM backplane 500 to the data card 503, using the SONET/ATM interface 501. The ATM multiplexer 508 also differentiates between voice, video and data communications and provides switched and permanent virtual circuits to the ATM switch 407. Some examples of the ATM multiplexer 508 include a TDMA and CDMA multiplexer.

In some examples of the invention, the voice card 504 could support digital telephony communications with the telephone 507 providing echo cancellation or other digital signal processing. In other examples of the invention, the voice card 504 could support analogue telephony communications to interwork analogue telephony signals with ATM signals. The voice card 504 provides power and dial tone to the telephone 507. The voice card 504 detects on-hook, off-hook, and DTMF tones. The telephony card 504 provides ringback and busy tones to the telephone 507.

The video card 501 supports digital video transmission to the television 506. The video card provides an MPEG interface to the television 506. The MPEG interface includes video drivers that receive MPEG formatted video in ATM cells and provides the video signals to the television 506.

The data card 503 supports data communications such as Internet access and interactive data services between the computer 505 and the SONET/ATM interface 501. The data card 505 could be a LAN card that supports an internal LAN in the customer premise 114. For example, the data card could support multiple Ethernet connections to multiple computers, e.g. 505, in the customer premise 114.

The other card 502 represent a number of different cards that could be incorporated in the user gateway 203 as a matter of design choice. For example, the other card could be a Java card that receives Java applets to provide a wide variety of tasks such as call waiting and call forwarding.

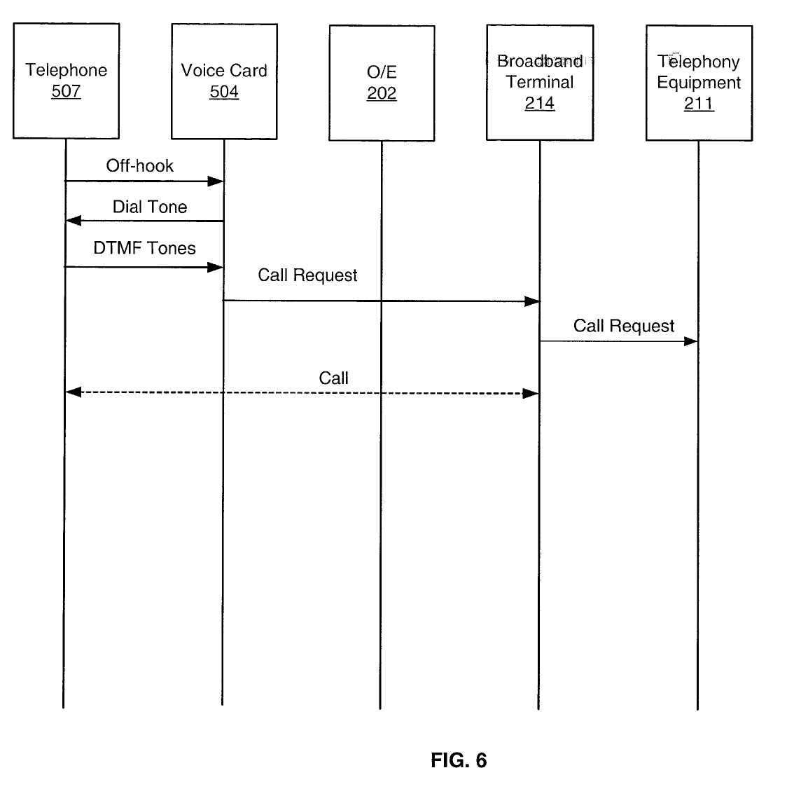

FIGS. 6-8 are message sequence charts illustrating an example of the operation of the user gateway 203. Referring first to FIG. 6 a voice call operation begins when the telephone 507 goes off-hook. The off-hook signal is received in the voice card 504 and the voice card 504 provides a dial tone to the telephone 507. Responsive to receiving DTMF tones representative of a called number from the telephone 507, the voice card 504 generates a call request message for the Broadband Terminal 214. The call request message is provided to the broadband terminal 214 over the ATM backplane 500, SONET/ATM interface 501 and ATM multiplexer 508.

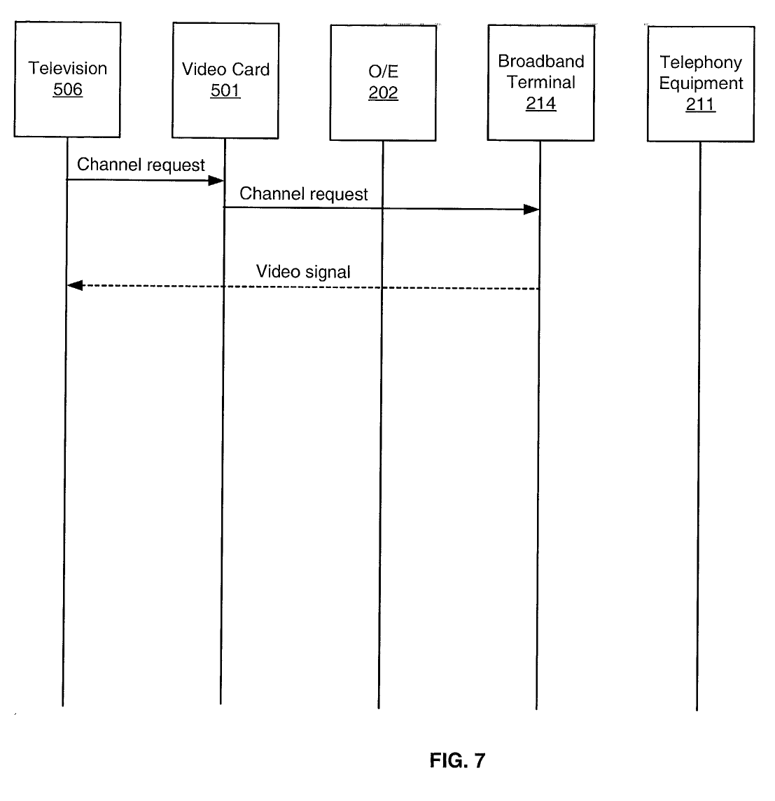

Referring to FIG. 7, substantially simultaneously, the television 507 could be switched on to a channel. The video card 504 detects the desired channel and generates a channel request message for the broadband terminal 214. Alternatively, a subscriber could switch the channel on the user gateway 203. The channel request message is provided to the broadband terminal 214 over the ATM backplane 500, SONET/ATM interface 501 and ATM multiplexer 508.

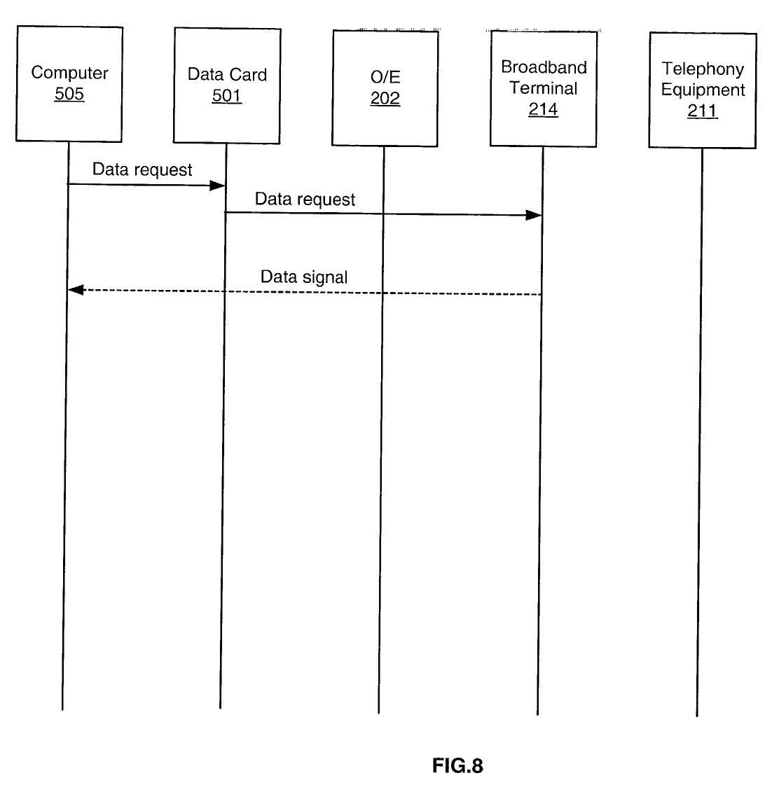

Referring to FIG. 8, substantially simultaneously a data request such as a web page could be received in the data card 503 from the computer 505. The data card 503 generates a data request message for the broadband terminal 214. The data request message is provided to the broadband terminal 214 over the ATM backplane 500, SONET/ATM interface 501 and ATM multiplexer 508.

The ATM multiplexer 508 combines the call request message, the channel request message, and the data request message into ATM cells and provides the ATM cells in an STS signal transmission to the O/E conversion node 202. For example the STS transmission could be an STS-12 transmission. The O/E conversion node 202 maps the STS-12 transmission to an OC-12 transmission and provides the OC-12 transmission to the broadband terminal 214. The broadband terminal 214 processes the OC-12 signal transmission using the ATM switch 407 and SONET/ATM interface 400 to provide the desired video channel signal back to the user gateway 203, exchange the call request message with the telephony equipment 211 to set up a call between the telephone 507 and a terminating call device, and exchange the data request message with the data network system 213 to provide the requested web page to the user gateway 203. The broadband terminal 214 provides the downstream traffic to the O/E conversion node 202 as an OC-12 transmission. The O/E conversion node 202 converts the OC-12 transmission into an STS-12 transmission and provides the downstream traffic to the user gateway 203.

The above-described elements can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing systems are integrated circuits and logic circuitry. Those skilled in the art are familiar with instructions, processing systems, and storage media.

Those skilled in the art will appreciate variations of the above-described embodiments that fall within the scope of the invention. As a result, the invention is not limited to the specific examples and illustrations discussed above, but only by the following claims and their equivalents.

What is claimed:

1. A method of providing broadband communications over a hybrid fiber coaxial (“HFC”) communication system, the method comprising:
receiving downstream voice video and data communications in a headend;
receiving into a user gateway located in a customer premise, upstream voice video and data communications from customer premise equipment; and
providing the downstream voice video and data communications from the headend to the user gateway at a synchronous optical network (“SONET”) transmission rate; and
providing the upstream voice video and data communications from the user gateway to the headend at the SONET transmission rate.

2. The method of claim 1 wherein providing the downstream voice video and data communications from the headend to the user gateway at the SONET transmission rate comprises:
providing over an optical communication link an optical carrier transmission including the downstream voice video and data communications from the headend to an optical to electrical conversion node;
in the optical to electrical conversion node, converting the optical carrier transmission into an electrical equivalent transmission; and
in the optical to electrical conversion node, providing the electrical equivalent transmission to the user gateway.

3. The method of claim 2, wherein providing the upstream voice video and data communications from the user gateway to the headend at the SONET transmission rate comprises:
in the user gateway, providing the electrical equivalent of the optical carrier transmission including the upstream voice video and data communications to the optical to electrical conversion node;
in the optical to electrical conversion node, converting the electrical equivalent of the optical carrier transmission rate to the optical carrier transmission rate; and
in the optical to electrical conversion node, providing the optical carrier transmission to the headend.

4. The method of claim 3, the method comprising:
providing the downstream voice video and data communications using an asynchronous transfer mode protocol; and
providing the upstream voice video and data communications from the user gateway to the headend using the asynchronous transfer mode protocol.

5. The method of claim 3, the method comprising:
providing the downstream voice video and data communications from the headend to the user gateway using an internet protocol; and
providing the upstream voice video and data communications from the user gateway to the headend using the internet protocol.

6. The method of claim 3, the method comprising:
compressing the upstream video communications using an MPEG format; and
compressing the downstream video communications using the MPEG format.

7. The method of claim 3, the method comprising:
providing the downstream voice video and data communications from the headend to the user gateway using code division multiplexing; and
providing the upstream voice video and data communications from the user gateway to the headend using code division multiplexing.

8. The method of claim 3, the method comprising:
providing the downstream voice video and data communications from the headend to the user gateway using time division multiplexing; and
providing the upstream voice video and data communications from the user gateway to the headend using time division multiplexing.

9. The method of claim 3, wherein the optical carrier transmission is at least an optical carrier twelve transmission.

10. The method of claim 3, wherein the electrical equivalent of the optical carrier transmission rate is a synchronous transport signal twelve transmission.

11. The method of claim 3 wherein the electrical equivalent of the optical carrier transmission rate is a synchronous transfer module transmission.

12. The method of claim 1 wherein the step of receiving upstream voice video and data communications in the user gateway comprises:
receiving a video request for a video transmission from a video device connected to the user gateway;
receiving a data request for a data transmission from a data device connected to the user gateway; and
receiving upstream voice communications from a call device connected to the user gateway.

13. The method of claim 12 wherein the step of providing the upstream voice video and data communications from the user gateway to the headend at the SONET transmission rate comprises:
providing the video request to the headend at the SONET transmission rate;
providing the data request to the headend at the SONET transmission rate; and
providing the upstream voice communications to the headend at the SONET transmission rate.

14. The method of claim 13 wherein the step of providing the downstream voice video and data communications between the headend and the user gateway at the SONET transmission rate comprises:
in the headend, processing the video request to provide the requested video transmission to the user gateway at the SONET transmission rate;
in the headend, processing the data request to provide the requested data transmission to the user gateway; and
in the headend, providing downstream voice communications from the headend to the user gateway at the SONET transmission rate.

15. The method of claim 14 the method comprising:
in the user gateway, providing the requested video transmission directly to the video device, wherein the video device is configured to display the requested video transmission to the user.

16. The method of claim 14 the method comprising:
in the user gateway, providing the requested data transmission directly to the data device, wherein the data device is configured to display the requested data transmission to the user.

17. The method claim 14 the method comprising:
exchanging the upstream and downstream voice communications directly between the user gateway and the call device.

18. A hybrid fiber coaxial (“HFC”) communication system comprising:
a broadband terminal configured to provide a first transmission comprising downstream voice video and data traffic over an optical communication link using an optical carrier transmission rate and receive a second transmission comprising upstream voice video and data traffic using the optical carrier transmission rate;
an optical to electrical conversion node configured to receive the first transmission from the broadband terminal over the optical communication link convert the first transmission to an electrical equivalent of the optical carrier transmission rate, transmit the first transmission over a coaxial communication link, receive the second transmission over the coaxial communication link, convert the second transmission from the electrical equivalent of the optical carrier transmission rate to the optical carrier transmission rate and provide the second transmission over the optical communication link to the broadband terminal; and
a user gateway configured to receive the first transmission from the optical to electrical conversion node, provide voice communications directly to a voice device, provide data communications directly to a data device configured to display the data communications for a user, provide video communications directly to a video device configured to display the video communications for the user, and generate the second transmission and transmit the second transmission at the electrical equivalent of the optical carrier transmission rate to the optical to electrical conversion node.

19. The system of claim 18 wherein the first transmission and the second transmission are an asynchronous transfer mode transmissions.

20. The system of claim 18 wherein the first transmission and the second transmission are an internet protocol transmission.

21. The system of claim 18 wherein the video communications are compressed using an MPEG format.

22. The system of claim 18 wherein the first transmission and the second transmission are code division multiplexed.

23. The system of claim 18 the first transmission and the second transmission are time division multiplexing.

24. The system of claim 18 wherein the optical carrier transmission rate is at least an optical carrier twelve transmission rate.

25. The system of claim 18 wherein the electrical equivalent of the optical carrier transmission rate is a synchronous transport signal twelve transmission rate.

26. The system of claim 18 wherein the electrical equivalent of the optical carrier transmission rate is a synchronous transport module transmission rate.

27. The system of claim 18 wherein the user gateway is configured to generate and provide a video request for a video transmission to the broadband terminal and the broadband terminal is configured to process the video request to provide the requested video transmission to user gateway.

28. The system of claim 18 wherein the user gateway is configured to generate and provide a data request for a data transmission to the broadband terminal and the broadband terminal is configured to process the data request to provide the requested data transmission to user gateway.

29. The system of claim 18 wherein the user gateway is configured to generate and provide a call request for a call to the broadband terminal and the broadband terminal is configured to process the call request to connect a call to user gateway

30. A user gateway configured to exchange voice video and data traffic between a headend and a call device configured for voice communication, a data device configured to display data information, and a video device configured to display video information, the user gateway comprising:
call processing means configured to receive a call request from the call device and process the call request to set up a call over the headend between the call device and a terminating call device;
video processing means configured to receive a video channel request from the video device and process the video channel request to provide a requested video channel from the headend to the video device;
data processing means configured to receive a data request message from the data device and process the data request message to provide requested data from the headend to the data device; and
SONET transport means configured to exchange call traffic including the call, video traffic including the video channel, and data traffic including the requested data between the user gateway and the headend at a SONET transmission rate.

31. The user gateway of claim 30 wherein the SONET transport means is configured to exchange the call traffic, video traffic, and data traffic between the user gateway and the headend using an asynchronous transport protocol.

32. The user gateway of claim 30 wherein the SONET transport means is configured to exchange the call traffic, video traffic, and data traffic between the user gateway and the headend using an internet protocol.

33. The user gateway of claim 30 wherein the SONET transmission rate is a synchronous transport signal.

34. The user gateway of claim 30 wherein the SONET transmission rate is a synchronous transport module.

35. The user gateway of claim 30 wherein the SONET transport means is configured to exchange the call traffic, video traffic, and data traffic between the user gateway and the headend using code division multiple access multiplexing.

36. The user gateway of claim 30 wherein the SONET transport means is configured to exchange the call traffic, video traffic, and data traffic between the user gateway and the headend using time division multiple access multiplexing.

37. The user gateway of claim 30 wherein the SONET transport means is configured to exchange the video traffic between the user gateway and the headend using MPEG compression format.

38. The user gateway of claim 30 wherein the call device is a telephone.

39. The user gateway of claim 29 wherein the data device is a computer.

40. The user gateway of claim 29 wherein the video device is a television.
